(19) United States
(12) Patent Application Publication
(10) Pub. No.: US 2013/0070094 A1
(43) Pub. Date: Mar. 21, 2013

(54) AUTOMATIC REGISTRATION OF MULTI-PROJECTOR DOME IMAGES

(71) Applicant: THE REGENTS OF THE UNIVERSITY OF CALIF, Oakland, CA (US)

(72) Inventors: ADITI MAJUMDER, IRVINE, CA (US); BEHZAD SAJADI, IRVINE, CA (US)

(73) Assignee: THE REGENTS OF THE UNIVERSITY OF CALIFORNIA, A CALIFORNIA CORPORATION, Oakland, CA (US)

(21) Appl. No.: 13/623,805

(22) Filed: Sep. 20, 2012

Related U.S. Application Data
(60) Provisional application No. 61/537,006, filed on Sep. 20, 2011.

(51) Int. Cl. G06K 9/32; H04N 7/18

(52) U.S. Cl. 348/143; 348/E07.085

(57) ABSTRACT

Automatic registration of projectors and their images on a curved surface may be performed using non-linear optimization techniques. A camera may capture images on the curved surface. The camera may be un-calibrated. The camera parameters may be estimated using a non-linear optimization of data in the images of the curved surface. The images may be from multiple projectors. In some embodiments, registration may be view independent.

### CROSS-REFERENCE TO RELATED APPLICATION

This application claims benefit under 35 U.S.C. §119(e) of U.S. Provisional Application having No. 61/537,006 filed Sep. 20, 2011, which is hereby incorporated by reference herein in its entirety.

### STATEMENT OF GOVERNMENT INTEREST

The invention described herein was made in the performance of official duties by one or more employees of the University of California University system, and the invention herein may be manufactured, practiced, used, and/or licensed by or for the government of the State of California without the payment of any royalties thereon or therefor. The funding source or government grant number associated with inventions described herein is NSF-IIS-0846144.

### BACKGROUND

The present invention relates to image projection and more specifically, to an automatic registration of multi-projector dome images.

Domes can create a tremendous sense of immersion and presence in visualization and virtual reality (VR) systems. They are becoming popular in many edutainment and visualization applications including planetariums and museums. Tiling multiple projectors on domes is a common way to increase their resolution. However, the challenge lies in registering the images from the multiple projectors in a seamless fashion to create one seamless display. Some known techniques employ calibrated stereo cameras. Typical conventional techniques may be relegated to niche expensive entertainment applications.

Accordingly there is a need for registering projectors on a dome using cost-effective approaches.

### SUMMARY

According to one aspect of the present invention, a method of registering images on a curved surface comprises capturing a display of images projected from multiple projectors on to the curved surface with a camera; estimating camera parameters of the camera using a non-linear optimization of data in the images of the curved surface captured by the camera; and registering the display of images on the curved surface using the estimated camera parameters.

According to another aspect of the present invention, a system, comprises a camera; a plurality of projectors coupled to the camera; and a controller coupled to the camera configured to: control the plurality of projectors to display overlapping segmented images onto a curved surface, receive information captured by the camera of the displayed segmented images, estimate camera parameters of the camera using the received information, and reconstruct the camera parameters based on the received information.

According to a further aspect of the present invention, a computer readable storage medium may include a computer readable code configured to: capture a display of images projected from multiple projectors on to a curved surface with a camera; define a coordinate system of the curved surface using a fiducial constraint; determine display to projector correspondences of the curved surface based on estimated camera parameters of the camera; backproject a blob onto the curved surface using the estimated camera parameters; and finding an intersection of the backprojected blob with the coordinate system of the curved surface.

These and other features, aspects and advantages of the present invention will become better understood with reference to the following drawings, description and claims.

### BRIEF DESCRIPTION OF THE SEVERAL VIEWS OF THE DRAWINGS

FIG. 1 is a perspective view of a registration system in accordance with an exemplary embodiment of the present invention;

FIG. 1A is a block diagram of the registration system of FIG. 1;

FIG. 2 is a world coordinate system in accordance with another exemplary embodiment of the present invention; and

FIG. 3 is a flowchart of a method of registering an image in accordance with still yet another exemplary embodiment of the present invention.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

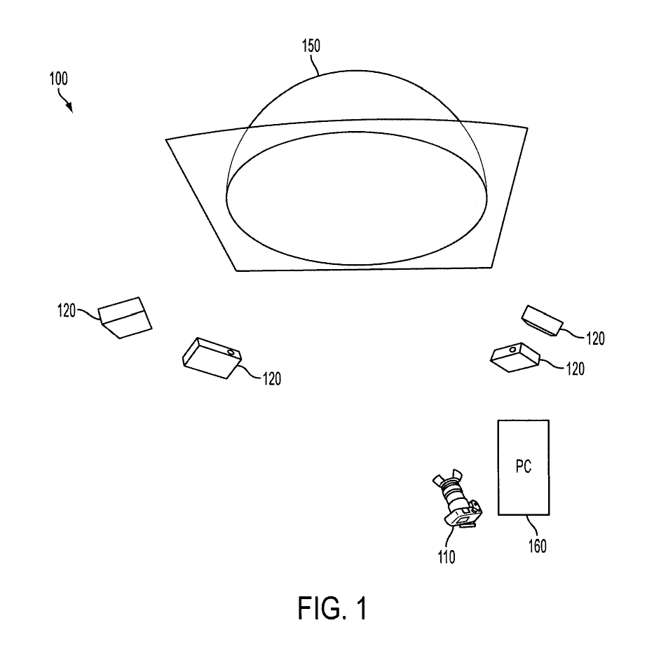

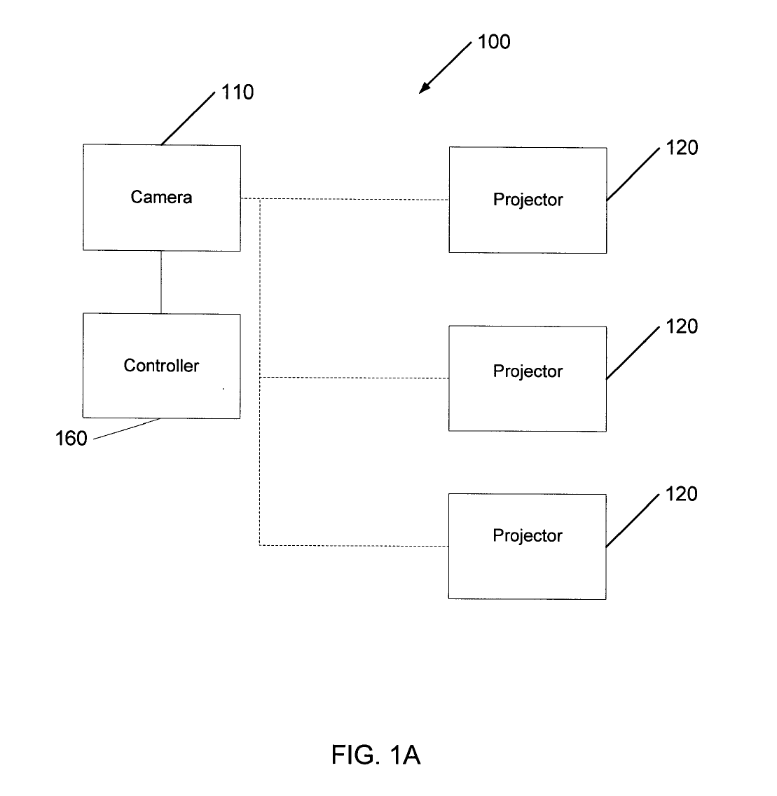

Broadly, embodiments of the subject technology may provide registration of images on a curved surface using un-calibrated cameras. Referring to FIGS. 1 and 1A, a system 100 is shown according to an exemplary embodiment if the present invention. The system 100 may include at least one un-calibrated camera 110 and a plurality of image projectors 120. The camera 100 may be for example, a video camera, a still type camera, or a digital type camera. The camera 110 and projectors 120 may be disposed to point at a curved surface 150. Although shown as floating, the projectors 120 may be fixed into arbitrary positions by mechanical supports. The camera 110 may be movable to capture different angles of the curved surface 150. The curved surface 150 may be for example, a hemi-spherical surface, a dome, or an asymmetric dome. The curved surface 150 may be interchangeably referred to as the dome 150.

The camera 110 and projectors 120 may be connected to a controller 160. The controller 160 may be, for example, a computer configured to perform the actions described herein. The controller 160 may include a memory and a processor (not shown) which may include code that when executed, performs method steps as described below. The controller 160 may be integrated into the camera 110 or may be a separate unit. The controller 160 may be hardwired to the camera 110 and/or to the projectors 120 or may be connected wirelessly to the camera 110 and projectors 120. The controller 160 may control the camera 110 and the projectors 120. Evaluation of data received from the camera 110 may be performed by the controller 160. In some embodiments, the control of the controller 160 may be in the form of a computer readable storage medium including computer code configured to perform the actions described herein. In some embodiments, the computer readable storage medium may be in non-transitory form. In some embodiments, the computer readable storage medium may be a tangible medium. While only one camera 110 is shown, it will be understood that some embodiments may employ multiple cameras however it may be appreciated that aspects of the present invention may require only a single camera.

An image of the dome 150 and a projected pattern from each projector 120 may be analyzed for image data to perform camera calibration (or camera resectioning) of the camera 110. In an exemplary embodiment, a non-linear optimization may be employed to reconstruct both intrinsic camera parameters and extrinsic camera parameters of the camera 110 during camera calibration. A single physical fiducial may be used to define a unique coordinate system for the dome 150. For sake of illustration, the camera 110 is shown in a single position with a single view available in its field of view. However, in some embodiments, the camera 100 may be movable so that when the whole display of images on the curved surface 150 (for example, a field of view seeing the scene comprising different image sections from the multiple projectors 120) can not be seen in a single camera view or the resolution of the display is much higher than the resolution of the camera 110, multiple pan and tilted views of the camera 110 may be used to register the images. Thus, it may be appreciated that the system 100 may be useful for displays of various resolution and size even when the camera 110 cannot be placed far enough to see the whole image in a single view. For example, when the camera 110 has a field of view that cannot capture the entire curved surface 150 (for example, a dome), the camera 100 may be placed directly under the center of the dome to acquire a first image and then may be placed at a tilted angle to acquire a quadrant or other partial section of the dome to acquire a second image. The camera 110 may be moved, after acquiring the second image, into a position to acquire another section of the dome from a different angle or panned view than the previous position.

The acquired images of the curved surface 150 may be analyzed by the controller 160 for information providing the camera's 110 parameters. Extrapolation of the camera 110 parameters is discussed in more detail below. After extrapolating the camera 110 parameters, each portion of the display image may projected by a different projector 120 to register them on the dome. The term “registration” will be understood to refer to image registration, for example, by transforming sets of data into a coordinate system. The images of the projected patterns may be used to relate projector 120 coordinates with display surface (curved surface 150) coordinates. This relationship may be represented using a set of rational Bezier patches to represent sections of the projected images on sections of the curved surface 150. For example, the display image may be segmented into sections projected by each projector 120. In some embodiments, the segmented portions of the display image may partially overlap with adjacent segmented portions. In some embodiments, the images can be registered for any arbitrary viewpoint making the system 100 suitable for a single head tracked user in three dimensional visualization applications. It may be appreciated that since domes may often be used for multi-user applications (e.g. planetariums), then the use of cartographic mapping techniques to wrap the image on the dome 150 for multi-viewing purposes is also available.

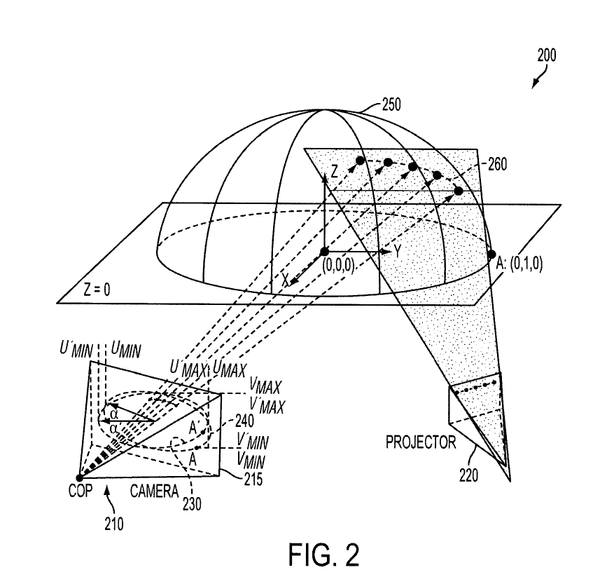

Referring now to FIGS. 1 and 2, a registration coordinate system 200 is shown according to an exemplary embodiment of the present invention. A non-linear optimization approach to finding camera parameters along a curved surface 150 may be used in the registration coordinate system 200. The registration coordinate system 200 may include a world coordinate system 250 and camera setup 210. The world coordinate system 250 may, in some embodiments, represent a curved surface, for example, the dome 150. The camera setup 210 may represent the position of the camera 110 relative to the dome 150. An image captured by the camera 110 (represented by ellipse 240) of the boundary of the dome 150 is shown in the image plane 215 of the camera setup 210. The re-projected boundary (represented by ellipse 230) may also be shown on the image plane 215. Also, a projected set of points 260 are shown. The projected set of points 260 may be collinear in the projector space 220. The three dimensional position of the detected points may be estimated using rayshooting and then tested for co-planarity.

In defining the world coordinate system 250, the radius of the curved surface may be 1. The equatorial plane of the curved surface may be the Z=0 plane and the center of the curved surface may be at (0; 0; 0). One fiducial may define the world coordinate system 250 unambiguously. A fiducial A may be defined with a coordinate of (0; 1; 0) on the equator of the curved surface. The fiducial may be used to extrapolate other points in the world coordinate system 250 with respect to their position relative to the fiducial.

The image planes of the camera 110 and the projectors may be parameterized by (u; v) and (s; t) respectively. By using an un-calibrated camera, both its intrinsic and extrinsic parameters may be unknown. For a system of n projectors, a registration algorithm may take n+1 images as input. The first image, I₀, may be of a hemispherical display with no projectors turned on. Next, for each projector i, 1≦i≦n, a picture Iᵢ may be taken of the same display surface with projector i projecting blobs that may form a grid of vertical and horizontal lines in the projectors' 120 image space. The total number of such grid lines may be m.

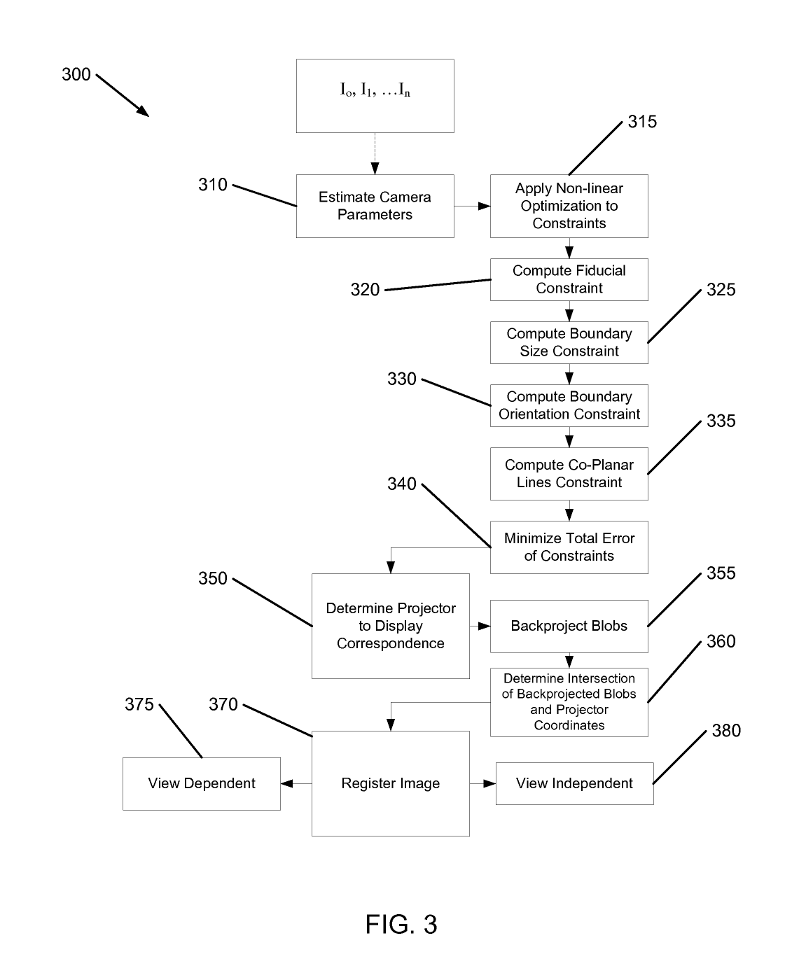

Referring now to FIG. 3, a method 300 of registering a display is shown according to an exemplary embodiment of the present invention. Registration of the display may be performed, for example, the controller 160 of FIG. 1. For a set of images I, the controller 160 may, in a step 310, estimate camera parameters. The camera parameters may include extrinsic and intrinsic properties. A non-linear optimization approach may be employed to estimate the camera parameters by analyzing data in images captured by the camera. The camera parameters estimated may include focal length, pose, and orientation. The input to this step is the set of images, I₀; Iᵢ . . . ; Iₙ, where 0, 1, . . . n may represent each projector i in a group of projectors. The output may be the 3×4 camera calibration matrix of a camera. The equator of the curved surface may be distinct from its surroundings and may be segmented easily in I₀. In each image Ii, the two dimensional coordinates of the blobs from projector i may be detected using a blob detection technique that is robust in the face of distortions created by the hemispherical display surface (curved surface). The two dimensional blobs coordinates may then be organized in groups Lij (line j in projector i) such that the blobs in each group may fall either on a vertical or a horizontal line in the projector image plane. Letting the total number of blobs in line Lij be mᵢⱼ, the total number of blobs from projector i may be given by mᵢ, where mᵢ=Σⱼ mᵢⱼ. Let M=K(R|RT) be the camera calibration matrix comprising the 3×3 intrinsic parameter matrix K and the 3×4 extrinsic parameter matrix (R|RT) that provides the pose and orientation of the camera. (R|RT) may comprise six parameters including three rotations to define the orientation and the three dimensional center of projection (COP) of the camera to define the position. If the camera intrinsic parameter matrix K is assumed to have only one unknown, the focal length f, the seven estimated parameters of the camera may include the focal length, the three rotation angles of its orientation and the three coordinates of its COP.

The controller 160 may in step 315, estimate these parameters by applying a non-linear optimization to the captured image data with the following constraints.

Fiducial Constraint:

The controller 160 may compute a fiducial constraint in step 320. In this constraint, the re-projection error E1 of the fiducial A may be minimized. Let (u_{A}; v_{A}) be the detected coordinate of A in I₀. The projected coordinate (u′_{A}; v′_{A}) is given by applying M to the 3D coordinates of A. The error E1=(u_{A}−u′_{A})²+(v_{A}−v′_{A})².

Boundary Size Constraint:

The controller 160 may compute a boundary size constraint in step 325. This may be a constraint on the size and position of the image of the equator of the dome. To measure the size in the image I₀, an axis-aligned bounding box given by (uₘᵢₙ; vₘᵢₙ) and (uₘₐₓ; vₘₐₓ) may be fitted. The equator of the curved surface in the world coordinate system may be defined as X²+Y²=0; Z=0. The equator may be re-projected (by projector?) on the camera image plane using M to get (u′ₘᵢₙ; v′ₘᵢₙ) and (u′ₘₐₓ; v′ₘₐₓ). The error E₂=(uₘᵢₙ−u′ₘᵢₙ)²+(vₘᵢₙ−v′ₘᵢₙ)²+(uₘₐₓ−u′ₘₐₓ)²+(vₘₐₓ−v′ₘₐₓ)².

Boundary Orientation Constraint:

The controller 160 may compute a boundary orientation constraint in step 330. This may be a constraint on the orientation of the boundary. The image of the equator in I₀ may be an ellipse in general. The major axis of this ellipse may be identified given by vector α. The equator may be reprojected on the camera image plane (as calculated by the controller 160) using matrix M and may identify its major axis α′. The angular deviation between α and α′ may be minimized. Hence, the error E3=(1−|α·α′|)² may be defined. This constraint together with the previous constraints may assure that the captured image of the equator and the reprojection of the equator on the image plane are identical.

Co-Planar Lines Constraint:

The controller 160 may compute a co-planar lines constraint in step 335. This constraint may be on the image of each line Lᵢⱼ in image Iᵢ to resolve the scale factor ambiguity and hence to help in finding the focal length of the camera. For this, ray casting may be used to back project the two dimensional images of all the mᵢⱼ blobs in Lᵢⱼ using M and find the corresponding three dimensional locations of the blobs on the curved surface. Note that all these three dimensional points may be coplanar since they are the projections of collinear points in the projector image plane. In order to evaluate this an mᵢⱼ×4 matrix Pᵢⱼ using these three dimensional coordinates where the first three elements of each row may be the 3D back-projected coordinates of a two dimensional blob lying on the image of Lᵢⱼ and the last element may be 1. The coplanarity of these points may be assured if the fourth eigenvalue of matrix Pᵢⱼ is zero. Hence, to enforce the coplanarity constraint for each line Lᵢⱼ, the error metric Eᵢⱼ may be defined as the square of the fourth eigenvalue of Pᵢⱼ for each line Lᵢⱼ. The total deviation of all the lines from coplanarity may defines the fourth error metric E4, wherein E4=(1/w)Σi ΣjΣij, where the weight w is given by 1/(ΣiΣjΣmᵢⱼ). This may allow the same importance to given to E4 as the previous error metrics irrespective of the number of blobs used.

Using the Fiducial, the Boundary Size, the Boundary orientation, and the Coplanar Lines (referred to hereafter as “E1”, “E2”, “E3” and “E4” respectively) constraints E=√(E1+E2+E3+E4) may be minimized in step 340 by the controller 160 in the non-linear optimization. To minimize E, standard gradient descent methods may be used. To assure faster convergence a pre-conditioning may be applied to the variables so that the range of values assigned to them may be normalized and a decaying step size may be used. Optimization may be initialized assuming the view direction of the camera to be aligned with the Z-axis. To initialize the distance of the camera an estimate of the vertical FOV covered by the screen in the camera image may be used. The height H of the image of the equator in pixels may be determined and then the center of projection may be initialized to be at (0; 0; (H/2 f). For the initial value of f, EXIF tags of the captured image may be used. The minimized E may be used to position the reprojection of the image relative to the reprojection of the equator on the image plane of the curved surface 150 (FIG. 1) with the least amount of error.

The controller 160, in step 350, may determine a projector to display correspondence. In this step the estimated camera parameters may be used and the two dimensional blobs identified on each image Iᵢ from projector to find the correspondences between the projector coordinates (s; t) and the three dimensional display coordinates (X; Y; Z). In step 355, each blob Qₖ, 1≦k≦mᵢ, in Iᵢ may, under the control of the controller 160, be backprojected onto the display surface by casting rays from the COP of the camera using the recovered camera parameters. The controller 160, in step 360, may find the intersection of the backprojected blobs with the curved display surface in three dimensional space. The back-projected position of blob Qₖ may be (Xₖ; Yₖ; Zₖ) and the position of the blob in the projector coordinate system may be (sₖ; tₖ). In order to relate the two dimensional coordinate system of the projector to the three dimensional coordinate system of the display three rational Bezier patches may be fitted, B_{X} (s; t), B_{Y} (s; t), and B_{Z}(s; t), using these correspondences such that

(X; Y; Z)=(B_{X}(s; t); B_{Y}(s; t); B_{Z}(s; t)): Equation (1)

To fit the rational Bezier patches a non-linear least squares fitting may be used solved efficiently by the Levenberg-Marquardt gradient descent optimization. (cite reference material) Using perspective projection invariant rational Bezier patches for interpolation instead of a simple linear interpolation may allow for accurate registration even with a sparse set of correspondences. This may also enable a camera 110 (FIG. 1) with low resolution capability to register the higher resolution hemispherical display.

A step 370 may include registration of images onto the curved surface of the display. Geometric registration may be performed in two different ways depending on the application: view-dependent and view independent.

In single user applications, such as three dimensional visualization, flight simulation, and three dimensional games, the controller 160, in step 375, may register the scene of images in a view-dependent manner, for example, a view that looks correct for an arbitrary desired viewpoint. In a view-dependent registration, a two-pass rendering approach may be used. The scene may be rendered from a virtual camera at the desired viewpoint. In the second pass, for every projector pixel (s; t), Equation 1 may be used to find the corresponding (X; Y; Z) display coordinate. This three dimensional point may be projected on the image plane of the virtual camera to assign the desired color.

In multiple user applications the controller 160, in step 380 may register the scene of images in a view independent manner, for example, where viewers may observe the same scene from different perspectives. The image may need to be wrapped on the surface of the dome in a manner appropriate for multi-viewing. Though this may depend largely on the application, the domain of map projections in cartography may be helpful for this purpose. For example, orthographic or stereographic projection or more complex Lamberts conformal conic or azimuthal equidistant projection may be used. Such projections may provide sensible information from all views making them suitable for multi-user viewing.

Some embodiments described thus far may assume the display surface to be a perfect hemisphere. However it may be common to have non-hemispherical dome which may truncated from the bottom (and not from the side of the pole) with a plane parallel to the equator. A non-hemispherical dome may result in an ambiguity between the focal length and the depth of the dome since the relative height of the dome with respect to its radius is unknown. In order to overcome this ambiguity, the ratio of the height of the dome with respect to its radius, B, may be determined. B may be taken into consideration to define the global coordinate system. Defining the world coordinate system may proceed as previously described except that while estimating the camera parameters the intersection of the rays from the camera may be performed with a partial hemisphere instead of a complete hemisphere.

The single-view registration approach may require the entire display to be visible from the single camera view. This cannot be assured when the display is large. In some embodiments, large displays may be registered using multiple overlapping partial views from an uncalibrated camera, mounted on a pan-tilt unit (PTU), to register multiple projectors on a vertically extruded display. In some embodiments, the use of multiple overlapping partial views may be used by allowing a translation between the center of rotation of the pan-and-tilt unit and the COP of the camera.

It should be understood, of course, that the foregoing relates to exemplary embodiments of the invention and that modifications may be made without departing from the spirit and scope of the invention as set forth in the following claims.

What is claimed is:

1. A method of registering images on a curved surface, comprising:
capturing a display of images projected from multiple projectors on to the curved surface with a camera;
estimating camera parameters of the camera using a non-linear optimization of data in the images of the curved surface captured by the camera; and
registering the display of images on the curved surface using the estimated camera parameters.

2. The method of claim 1, wherein the curved surface is a dome.

3. The method of claim 1, wherein the camera is un-calibrated.

4. The method of claim 3, wherein the camera parameters estimated are intrinsic and extrinsic camera parameters.

5. The method of claim 1, wherein the display of images are segmented images, wherein adjacent images partially overlap.

6. The method of claim 1, wherein the images are used as a relationship of projector coordinates with display surface coordinates.

7. The method of claim 6, wherein the relationship is represented using a set of rational Bezier patches.

8. A system, comprising:
a camera;
a plurality of projectors coupled to the camera; and
a controller coupled to the camera configured to:
control the plurality of projectors to display overlapping segmented images onto a curved surface,
receive information captured by the camera of the displayed segmented images,
estimate camera parameters of the camera using the received information, and
reconstruct the camera parameters based on the received information.

9. The system of claim 8, wherein the camera parameters are intrinsic and extrinsic camera properties.

10. The system of claim 8, wherein the received information is processed under a non-linear optimization.

11. The system of claim 8, wherein the curved surface is a partial hemisphere.

12. The system of claim 8, wherein a registration of the segmented images is configured as view dependent.

13. The system of claim 8, wherein the segmented images are registered in the curved surface.

14. The system of claim 8, wherein the segmented images are registered for any arbitrary viewpoint.

15. A computer readable storage medium including a computer readable code configured to:
capture a display of images projected from multiple projectors on to a curved surface with a camera;
define a coordinate system of the curved surface using a fiducial constraint;
determine display to projector correspondences of the curved surface based on estimated camera parameters of the camera;
backproject a blob onto the curved surface using the estimated camera parameters; and
finding an intersection of the backprojected blob with the coordinate system of the curved surface.

16. The computer readable storage medium of claim 15, comprising performing a view independent registration of the captured display of images on the curved surface.

17. The computer readable storage medium of claim 16, wherein the registration is configured for view from different perspectives.

18. The computer readable storage medium of claim 15, wherein the camera parameters estimated are intrinsic and extrinsic camera parameters.

19. The computer readable storage medium of claim 15, wherein the non-linear optimization uses Bezier patches.

20. The computer readable storage medium of claim 18, wherein the Bezier patches include using a non-linear least squares fitting.
